(19) United States
(12) Patent Application Publication
(10) Pub. No.: US 2012/0092336 A1
(43) Pub. Date: Apr. 19, 2012

(54) 3D PLASMA DISPLAY

(76) Inventors: Choonsub KIM, Seoul (KR); Kisoo Ha, Seoul (KR); Jinyoung Oh, Seoul (KR); Minseok Choi, Seoul (KR)

(21) Appl. No.: 13/271,458

(22) Filed: Oct. 12, 2011

(30) Foreign Application Priority Data
Oct. 13, 2010 (KR) 10-2010-0099862

(51) Int. Cl. G06T 15/00

(52) U.S. Cl. 345/419

(57) ABSTRACT

A 3D plasma display includes a plasma display panel and a driver which implements an image on a screen of the plasma display panel in a frame including a plurality of subfields and transmits an emitter signal to 3D glasses. A time difference between the emitter signal and a start time point of the frame when an average power level (APL) is a first level is different from a time difference between the emitter signal and a start time point of the frame when the APL is a second level different from the first level.

This application claims the benefit of Korean Patent Application No. 10-2010-0099862 filed on Oct. 13, 2010, which is incorporated herein by reference for all purposes as if fully set forth herein.

### BACKGROUND OF THE INVENTION

1. Field of the Invention

Embodiments of the invention relate to a 3D plasma display.

2. Description of the Related Art

A 3D plasma display includes a plasma display panel.

A plasma display panel includes a phosphor layer inside discharge cells partitioned by barrier ribs and a plurality of electrodes.

When driving signals are applied to the electrodes of the plasma display panel, a discharge occurs inside the discharge cells. More specifically, when the discharge occurs in the discharge cells by applying the driving signals to the electrodes, a discharge gas filled in the discharge cells generates vacuum ultraviolet rays, which thereby cause phosphors between the barrier ribs to emit visible light. An image is displayed on the screen of the plasma display panel using the visible light.

### SUMMARY OF THE INVENTION

In one aspect, there is a 3D plasma display comprising a plasma display panel, and a driver configured to implement an image on a screen of the plasma display panel in a frame including a plurality of subfields and transmit an emitter signal to 3D glasses, wherein a time difference between the emitter signal and a start time point of the frame when an average power level (APL) is a first level is different from a time difference between the emitter signal and a start time point of the frame when the APL is a second level different from the first level.

In another aspect, there is a 3D plasma display comprising a plasma display panel including a scan electrode and a sustain electrode positioned parallel to each other, 3D glasses including a left eye lens and a right eye lens, and a driver configured to implement an image on a screen of the plasma display panel in a frame including a plurality of subfields and transmit an emitter signal to the 3D glasses, wherein the driver supplies a reset signal to the scan electrode in a reset period of at least one of the plurality of subfields and supplies a sustain signal to at least one of the scan electrode and the sustain electrode in a sustain period following the reset period, wherein the total number of sustain signals assigned to a second frame belonging to the frame is less than the total number of sustain signals assigned to a first frame belonging to the frame, wherein a time difference between the emitter signal and the reset signal supplied to the scan electrode in a reset period of a first subfield of the second frame is greater than a time difference between the emitter signal and the reset signal supplied to the scan electrode in a reset period of a first subfield of the first frame.

In yet another aspect, there is a 3D plasma display comprising a plasma display panel including a scan electrode and a sustain electrode positioned parallel to each other, 3D glasses including a left eye lens and a right eye lens, and a driver configured to implement an image on a screen of the plasma display panel in a frame including a plurality of subfields and transmit an emitter signal to the 3D glasses, wherein the driver supplies a reset signal to the scan electrode in a reset period of at least one of the plurality of subfields and supplies a sustain signal to at least one of the scan electrode and the sustain electrode in a sustain period following the reset period, wherein the total number of sustain signals assigned to a second frame belonging to the frame is less than the total number of sustain signals assigned to a first frame belonging to the frame, wherein an application time point of the reset signal supplied to the scan electrode in a reset period of a first subfield of the first frame is earlier than an application time point of the emitter signal, wherein an application time point of the reset signal supplied to the scan electrode in a reset period of a first subfield of the second frame is later than the application time point of the emitter signal.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIGS. 1 to 6 illustrate a configuration and a driving method of a 3D plasma display according to an example embodiment of the invention;

FIGS. 7 to 10 illustrate an emitter signal;

FIGS. 11 to 14 illustrate an average power level (APL);

FIGS. 15 to 28 illustrate a method for driving a 3D plasma display according to an example embodiment of the invention; and

FIGS. 29 and 30 illustrate another method for driving a 3D plasma display according to an example embodiment of the invention.

### DETAILED DESCRIPTION OF EMBODIMENTS

Reference will now be made in detail embodiments of the invention examples of which are illustrated in the accompanying drawings.

According to various embodiments of the invention, any one or more features from one embodiment/example/variation of the invention can be applied to (e.g., added, substituted, modified, etc.) any one or more other embodiments/examples/variations discussed below according to the invention. Further any operations/methods discussed below can be implemented in any of these devices/units or other suitable devices/units.

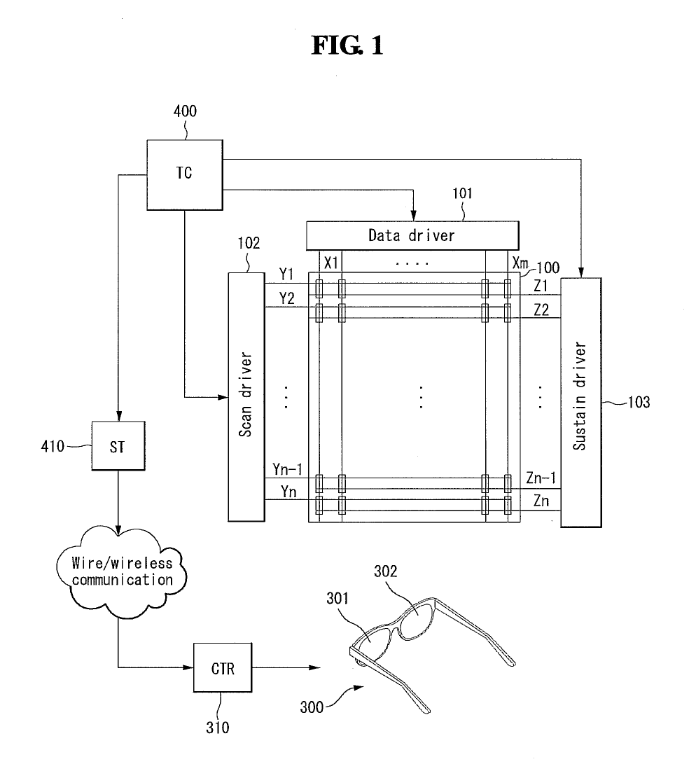

FIGS. 1 to 6 illustrate a configuration and a driving method of a 3D plasma display according to an example embodiment of the invention.

As shown in FIG. 1, the 3D plasma display according to the embodiment of the invention may include a plasma display panel 100 and a driver.

The driver may include a data driver 101, a scan driver 102, a sustain driver 103, 3D glasses 300, a timing controller 400, a signal transmitter 410, and a 3D glasses controller 310.

In FIG. 1, each of the data driver 101, the scan driver 102, and the sustain driver 103 is formed on a different board. However, at least two of the data driver 101, the scan driver 102, and the sustain driver 103 may be formed on one board or may form an integral body. For example, the scan driver 102 and the sustain driver 103 may be formed on one board.

The data driver 101 may supply a driving signal, for example, a data signal to address electrodes X1-Xm of the plasma display panel 100.

The scan driver 102 may supply a driving signal, for example, a scan signal to scan electrodes Y1-Yn of the plasma display panel 100.

The sustain driver 103 may supply a driving signal, for example, a sustain signal to sustain electrodes Z1-Zn of the plasma display panel 100.

The timing controller 400 may supply a predetermined timing control signal to each of the data driver 101, the scan driver 102, the sustain driver 103, and the signal transmitter 410, so as to control timing of the driving signals. Further, the timing controller 400 may generate an emitter signal for controlling turn-on and turn-off operations of a left eye lens 301 and a right eye lens 302 of the 3D glasses 300.

The signal transmitter 410 may transfer the emitter signal through wire/wireless communication under the control of the timing controller 400. Thus, the signal transmitter 410 for transferring the emitter signal may be referred to as an emitter. The emitter signal may be changed into various formats.

The 3D glasses controller 310 may turn on or off the left eye lens 301 and the right eye lens 302 of the 3D glasses 300 in response to the emitter signal received from the signal transmitter 410.

More specifically, the timing controller 400 may generate the emitter signal, which may turn on the left eye lens 301 in a left eye frame and may turn on the right eye lens 302 in a right eye frame. The timing controller 400 may transfer the emitter signal to the 3D glasses controller 310 through the signal transmitter 410. The 3D glasses controller 310 may control the turn-on and turn-off operations of the left eye lens 301 and the right eye lens 302 in response to the emitter signal received from the timing controller 400.

Preferably, the timing controller 400 may supply the timing control signal, i.e., the emitter signal to the 3D glasses 300 through the signal transmitter 410, thereby controlling turn-on and turn-off time points of the left eye lens 301 and the right eye lens 302.

It may be preferable that each of the left eye lens 301 and the right eye lens 302 includes a liquid crystal layer (not shown), whose molecular arrangement varies based on a voltage applied to each of the left eye lens 301 and the right eye lens 302, so as to turn on or off the left eye lens 301 and the right eye lens 302 in response to the emitter signal.

A viewer wearing the 3D glasses 300 perceives an image displayed in the left eye frame through his or her left eye and perceives an image displayed in the right eye frame through his/her right eye. Thus, a visual effect, in which the 3D image is implemented on the screen of the 3D plasma display, may be obtained.

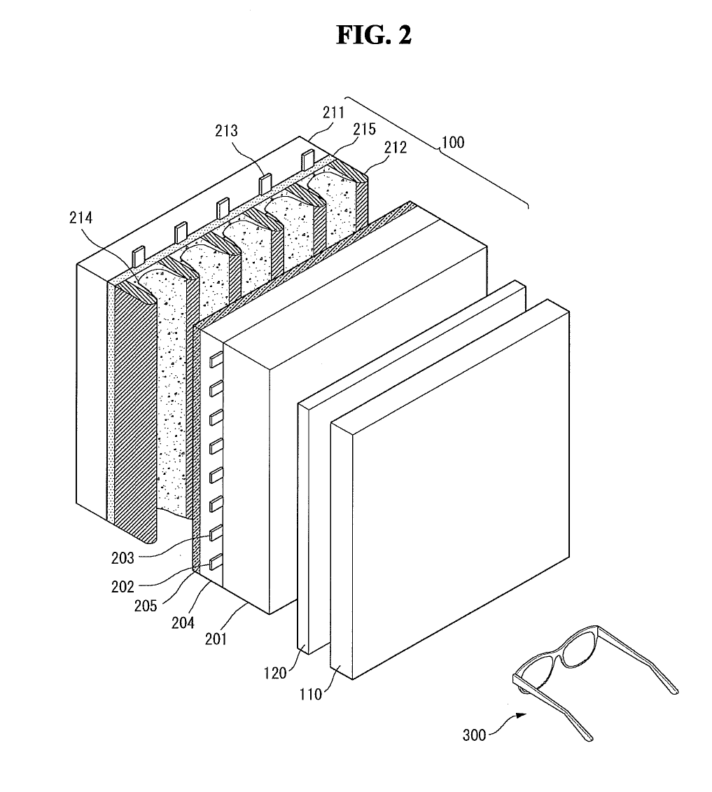

FIG. 2 illustrates the plasma display panel.

The plasma display panel 100 may display an image in the left eye frame including at least one subfield and the right eye frame including at least one subfield.

As shown in FIG. 2, the plasma display panel 100 may include a back substrate 211, on which a plurality of second electrodes 213 are formed to cross a plurality of first electrodes 202 and 203.

In the embodiment of the invention, the first electrodes 202 and 203 may include scan electrodes 202 and sustain electrodes 203 substantially parallel to each other, and the second electrodes 213 may be address electrodes.

An upper dielectric layer 204 may be formed on a front substrate 201, on which the scan electrodes 202 and the sustain electrodes 203 are formed, to limit a discharge current of the scan electrode 202 and the sustain electrode 203 and to provide insulation between the scan electrode 202 and the sustain electrode 203.

A protective layer 205 may be formed on the front substrate 201, on which the upper dielectric layer 204 is formed, to facilitate discharge conditions. The protective layer 205 may be formed of a material having a high secondary electron emission coefficient, for example, magnesium oxide (MgO).

A lower dielectric layer 215 may be formed on the back substrate 211, on which the address electrodes 213 are formed, to cover the address electrodes 213 and to provide insulation between the address electrodes 213.

A plurality of barrier ribs 212 of a stripe type, a well type, a delta type, a honeycomb type, etc. may be formed on the lower dielectric layer 215 to provide discharge spaces, i.e., discharge cells. Hence, a first discharge cell emitting red light, a second discharge cell emitting blue light, and a third discharge cell emitting green light, etc. may be formed between the front substrate 201 and the back substrate 211. Each of the barrier ribs 212 may include first and second barrier ribs each having a different height.

The address electrode 213 may cross the scan electrode 202 and the sustain electrode 203 in each discharge cell. Namely, each discharge cell is formed at a crossing of the scan electrode 202, the sustain electrode 203, and the address electrode 213.

Each of the discharge cells provided by the barrier ribs 212 may be filled with a predetermined discharge gas.

A phosphor layer 214 may be formed inside the discharge cell to emit visible light for an image display during an address discharge. For example, first, second, and third phosphor layers that respectively emit red, blue, and green light may be formed inside the discharge cell.

While the address electrode 213 on the back substrate 211 may have a substantially constant width or thickness, a width or thickness of the address electrode 213 inside the discharge cell may be different from a width or thickness of the address electrode 213 outside the discharge cell. For example, a width or thickness of the address electrode 213 inside the discharge cell may be greater than a width or thickness of the address electrode 213 outside the discharge cell.

When a predetermined signal is supplied to at least one of the scan electrode 202, the sustain electrode 203, and the address electrode 213, a discharge may occur inside the discharge cell. The discharge may allow the discharge gas filled in the discharge cell to generate ultraviolet rays. The ultraviolet rays may be incident on phosphor particles of the phosphor layer 214, and then the phosphor particles may emit visible light. Hence, a predetermined image may be displayed on the screen of the plasma display panel 100.

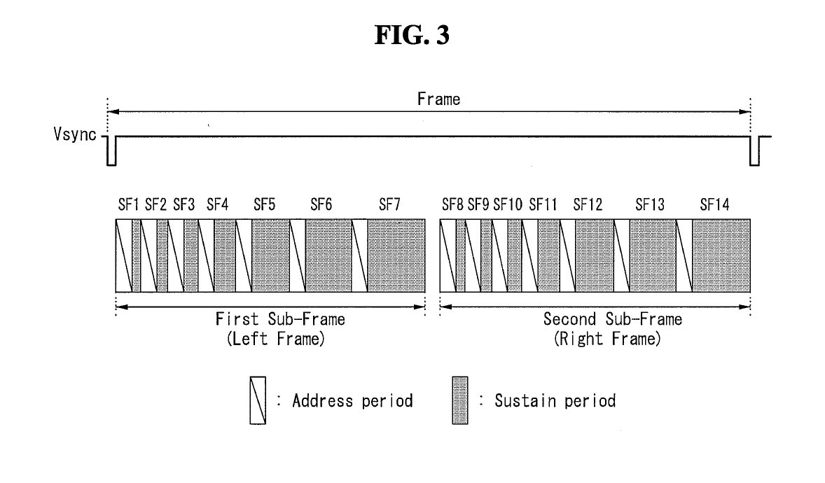

FIG. 3 illustrates an example of a frame for implementing a 3D image.

As shown in FIG. 3, a frame for representing a gray level of a 3D image may include a plurality of subframes each including at least one subfield. For example, as shown in FIG. 3, one frame may include first and second subframes each including at least one subfield.

In FIG. 3, the first subframe may be a left eye frame corresponding to the left eye lens, and the second subframe may be a right eye frame corresponding to the right eye lens. Namely, the one frame may include the left eye frame corresponding to a left eye image and the right eye frame corresponding to a right eye image.

Positions of the first subframe and the second subframe may be changed with each other. The number of subfields included in each of the first and second subframes may be variously changed.

The subfield may include an address period, in which the discharge cells not to generate a discharge are selected or the discharge cells to generate a discharge are selected, and a sustain period, in which a gray level is represented depending on the number of discharges.

For example, each of the first and second subframes may include seven subfields for representing 128-gray level, and each of the seven subfields may include an address period and a sustain period.

Furthermore, at least one of the plurality of subfields of a frame may further include a reset period for initialization. Preferably, a first subfield of the subframe may include a reset period in which a reset signal is supplied to the scan electrode.

A weight value of each of the subfields may be set by adjusting the number of sustain signals supplied during the sustain period. Namely, a predetermined weight value may be assigned to each subfield using the sustain period. For example, in such a method of setting a weight value of a first subfield at 2⁰ and a weight value of a second subfield at 2¹, the weight value of each subfield may increase in a rate of 2ⁿ (where, n=0, 1, 2, 3, 4, 5, and 6). Hence, gray levels of various images may be represented by adjusting the number of sustain signals supplied in the sustain period of each subfield based on the weight value of each subfield.

In FIG. 3, the number of subfields constituting the first subframe is substantially equal to the number of subfields constituting the second subframe. However, the number of subfields constituting the first subframe may be different from the number of subfields constituting the second subframe.

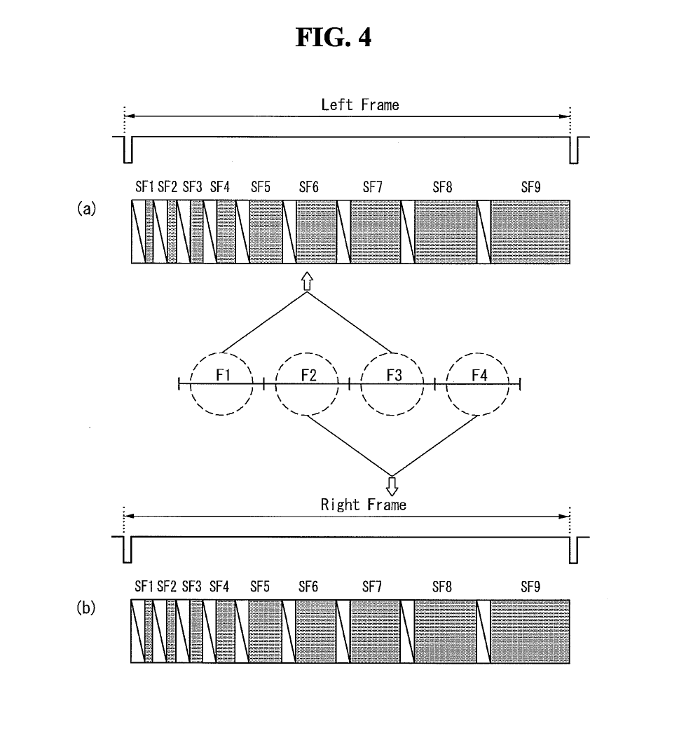

As shown in FIG. 4, each of the left eye frame and the right eye frame may constitute one frame. For example, first and third frames F1 and F3 of a plurality of successively arranged frames may be the left eye frames, and second and fourth frames F2 and F4 may be the right eye frames.

As above, one frame may include the left eye frame and the right eye frame. Alternatively, the left eye frame and the right eye frame may different frames.

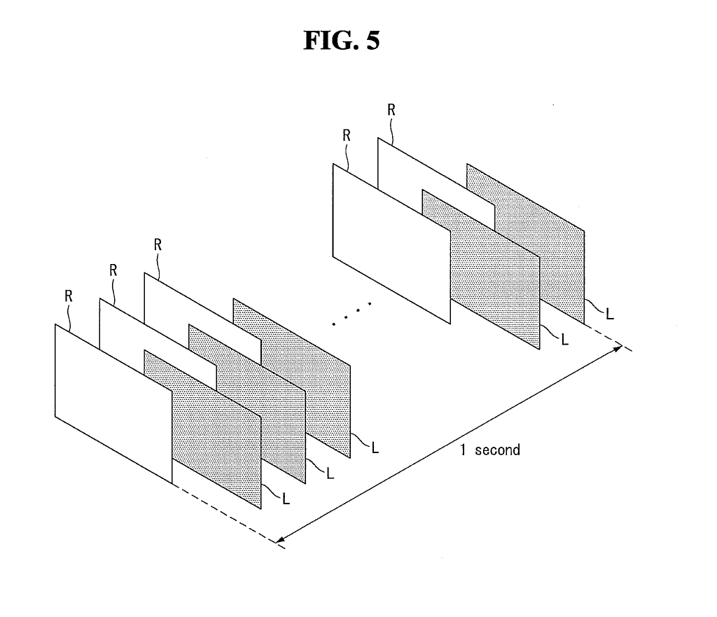

As shown in FIG. 5, when a 3D image according to a total of 120 frames (i.e., 120 Hz) is implemented for one second, 60 left eye frames and 60 right eye frames may be alternately arranged. In this instance, the right eye lens 302 is turned on and the left eye lens 301 is turned off in the right eye frames. Further, the left eye lens 301 is turned on and the right eye lens 302 is turned off in the left eye frames. In this instance, each of the left eye frame and the right eye frame may constitute one frame.

When the left eye frame and the right eye frame constitute one frame as shown in FIG. 3, a 3D image according to a total of 60 frames (i.e., 60 Hz) may be implemented for one second. In this instance, 60 left eye frames and 60 right eye frames may be alternately arranged.

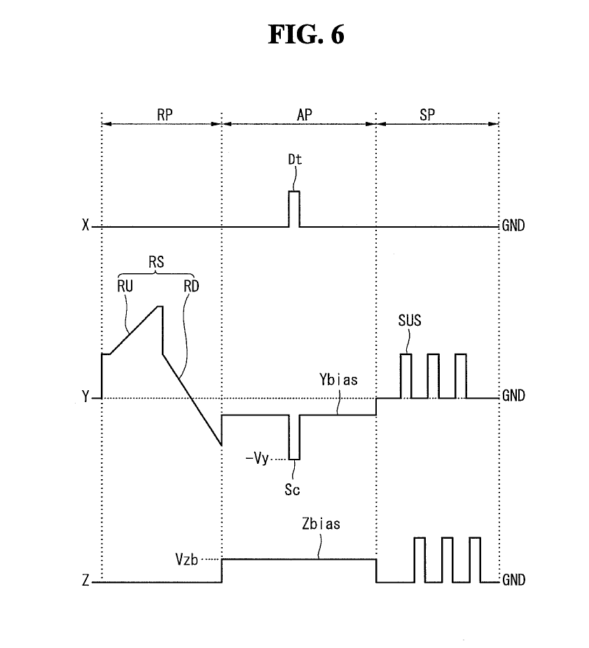

FIG. 6 illustrates an example of a driving waveform for driving the plasma display panel.

As shown in FIG. 6, a reset signal RS may be supplied to the scan electrode Y during a reset period RP for initialization of at least one of a plurality of subfields of a frame. The reset signal RS may include a ramp-up signal RU with a gradually rising voltage and a ramp-down signal RD with a gradually falling voltage.

More specifically, the ramp-up signal RU may be supplied to the scan electrode Y during a setup period of the reset period RP, and the ramp-down signal RD may be supplied to the scan electrode Y during a set-down period following the setup period. The ramp-up signal RU supplied to the scan electrode Y may generate a weak dark discharge (i.e., a setup discharge) inside the discharge cells. Hence, wall charges may be uniformly distributed inside the discharge cells. The ramp-down signal RD subsequent to the ramp-up signal RU may generate a weak erase discharge (i.e., a set-down discharge) inside the discharge cells. Hence, the remaining wall charges may be uniformly distributed inside the discharge cells to the extent that an address discharge occurs stably.

During an address period AP following the reset period RP, a scan reference signal Ybias having a voltage greater than a minimum voltage of the ramp-down signal RD may be supplied to the scan electrode Y. In addition, a scan signal Sc falling from a voltage of the scan reference signal Ybias may be supplied to the scan electrode Y.

A pulse width of a scan signal supplied to the scan electrode during an address period of at least one subfield of a frame may be different from pulse widths of scan signals supplied during address periods of the other subfields of the frame. A pulse width of a scan signal in a subfield may be greater than a pulse width of a scan signal in a next subfield. For example, a pulse width of the scan signal may be gradually reduced in the order of 2.6 μs, 2.3 μs, 2.1 μS, 1.9 μs, etc. or may be reduced in the order of 2.6 μs, 2.3 μs, 2.3 μs, 2.1 μs, . . . , 1.9 μs, 1.9 μs, etc. in the successively arranged subfields.

As above, when the scan signal Sc is supplied to the scan electrode Y, a data signal Dt corresponding to the scan signal Sc may be supplied to the address electrode X. As a voltage difference between the scan signal Sc and the data signal Dt is added to a wall voltage obtained by the wall charges produced during the reset period RP, an address discharge may occur inside the discharge cell to which the data signal Dt is supplied. In addition, during the address period AP, a sustain reference signal Zbias may be supplied to the sustain electrode Z, so that the address discharge efficiently occurs between the scan electrode Y and the address electrode X.

During a sustain period SP following the address period AP, a sustain signal SUS may be supplied to at least one of the scan electrode Y and the sustain electrode Z. For example, the sustain signal SUS may be alternately supplied to the scan electrode Y and the sustain electrode Z. As the wall voltage inside the discharge cell selected by performing the address discharge is added to a sustain voltage Vs of the sustain signal SUS, every time the sustain signal SUS is supplied, a sustain discharge, i.e., a display discharge may occur between the scan electrode Y and the sustain electrode Z.

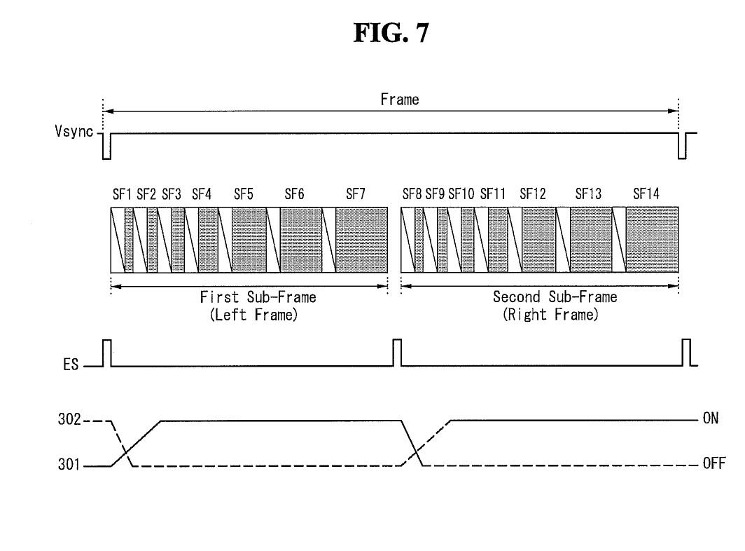

FIGS. 7 to 10 illustrate an emitter signal. In the following description, the descriptions of the configuration and the structure described above are omitted. For example, the following method may be applied to the case where one frame includes the left eye frame and the right eye frame and the case where the left eye frame and the right eye frame are different frames.

As shown in FIG. 7, an emitter signal ES may be a signal for turning on or off the left eye lens 301 and the right eye lens 302 of the 3D glasses. For example, when the emitter signal ES is applied to the 3D glasses, the left eye lens 301 may be turned on and the right eye lens 302 may be turned off Further, when a next emitter signal ES is applied to the 3D glasses, the right eye lens 302 may be turned on and the left eye lens 301 may be turned off

The emitter signal ES is generated between two successively arranged frames and may be generated between a left eye frame and a right eye frame.

For example, when the emitter signal ES is applied to the 3D glasses in a period between a first frame F1 and a second frame F2, the left eye lens 301 may be turned on. When the emitter signal ES is applied to the 3D glasses in a period between a left eye frame and a right eye frame in each of the first and second frames F1 and F2, the left eye lens 301 may be turned off and the right eye lens 302 may be turned on.

In FIG. 7, the emitter signal ES may be applied between the left eye frame and the right eye frame.

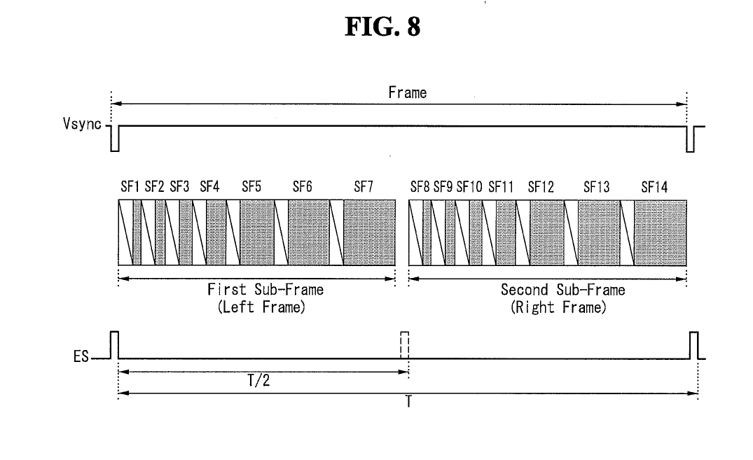

Alternatively, as shown in FIG. 8, the emitter signal ES is not applied to the 3D glasses in a period between a left eye frame and a right eye frame of one frame, the emitter signal ES may be applied to the 3D glasses in a period between two successively arranged frames.

In this instance, the turn-on and turn-off operations between the left eye lens 301 and the right eye lens 302 may be switched at a time point T/2 corresponding to one half of about one period T of the emitter signal ES, so as to divide the left eye frame from the right eye frame. For this, the 3D glasses controller 310 shown in FIG. 1 confirms the one period T of the emitter signal ES and then calculates the time point T/2 corresponding to one half of the one period T of the emitter signal ES. According to the calculation result, the turn-on and turn-off operations between the left eye lens 301 and the right eye lens 302 may be switched at the time point T/2 corresponding to one half of about one period T of the emitter signal ES.

In FIG. 8, the emitter signal ES may be applied between the two successively arranged frames.

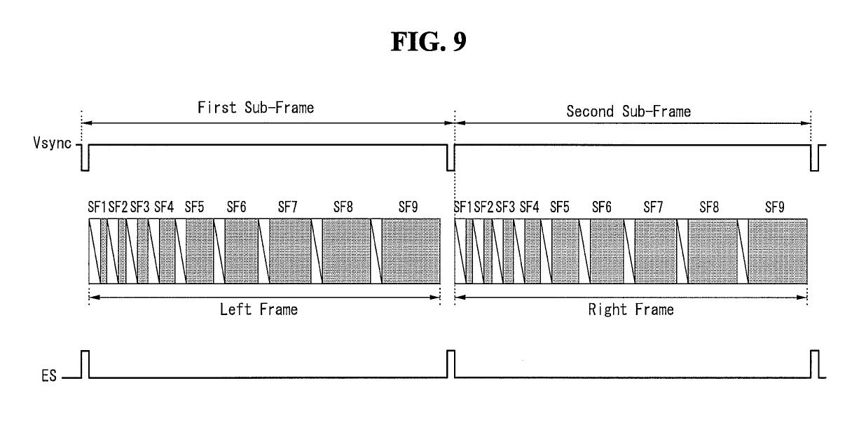

As shown in FIG. 9, when each of a left eye frame and a right eye frame constitutes one frame, the emitter signal ES may be applied between two successively arranged frames. The configuration was described above with reference to FIG. 4.

As shown in FIGS. 7 to 9, the emitter signal ES may be applied between the left eye frame and the right eye frame of one frame or between the two successively arranged frames.

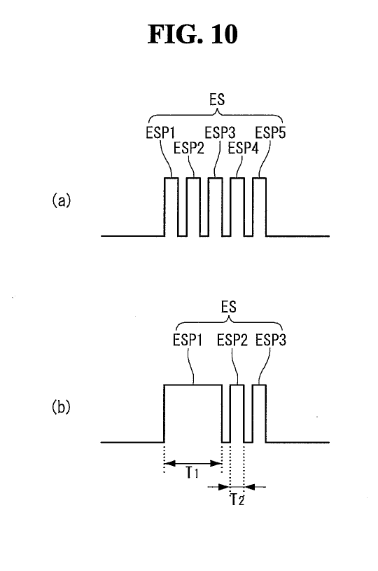

The form of the emitter signal ES may be variously changed. For example, as shown in FIG. 10(a), the emitter signal ES may include a plurality of pulses ESP1 to ESP5.

In this instance, the 3D glasses may recognize that the emitter signal ES is applied by confirming the last pulse ESP5 of the emitter signal ES. For example, when the 3D glasses recognize only the four pulses ESP1 to ESP4 of the emitter signal ES and do not recognize the last pulse ESP5, the 3D glasses may recognize an input signal as a noise. Hence, the erroneous operation of the 3D glasses resulting from the noise may be prevented.

Alternatively, as shown in FIG. 10(b), the emitter signal ES may include a plurality of pulses ESP1 to ESP3. At least one of the pulses ESP1 to ESP3 may be different from the other pulses. For example, a width T1 of the first pulse ESP1 of the pulses ESP1 to ESP3 may be greater than a width T2 of the other pulses ESP2 and ESP3. In this instance, the erroneous operation of the 3D glasses resulting from the noise may be prevented.

Alternatively, the emitter signal ES for turning on the left eye lens 301 may be different from the emitter signal ES for turning on the right eye lens 302. For example, to know whether the emitter signal ES currently input when the emitter signal ES is generated between the left eye frame and the right eye frame is a signal corresponding to the left eye lens 301 or a signal corresponding to the right eye lens 302, the emitter signal ES for turning on the left eye lens 301 may have the configuration shown in FIG. 10(a) and the emitter signal ES for turning on the right eye lens 302 may have the configuration shown in FIG. 10(b). In this instance, the operational stability of the 3D glasses may be improved.

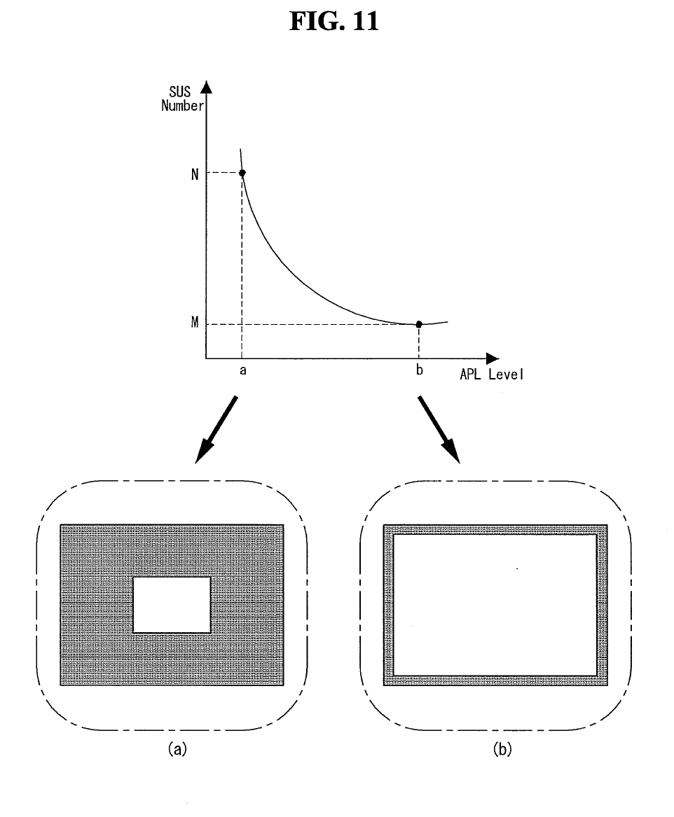

FIGS. 11 to 14 illustrate an average power level (APL).

FIG. 11 illustrates a conception of the APL.

The APL may be a method for adjusting the number of sustain signals in consideration of power consumption. More specifically, the APL may allow the number of sustain signals assigned to one frame to decrease in an increasing direction of power consumption and the number of sustain signals assigned to one frame to increase in a decreasing direction of power consumption.

For example, as shown in FIG. 11(a), when an image is displayed on a relatively small-sized portion of the screen of the plasma display panel (i.e., when the APL is relatively low), power consumption may be relatively low. Therefore, the number of sustain signals assigned to one frame may relatively increase. Hence, an entire luminance of the image may increase.

On the other hand, as shown in FIG. 11(b), when an image is displayed on a relatively large-sized portion of the screen of the plasma display panel (i.e., when the APL is relatively high), power consumption may be relatively high. Therefore, the number of sustain signals assigned to one frame may relatively decrease. Hence, an excessive increase in power consumption may be prevented.

For example, as shown in FIG. 11, when the APL is “a” level, the number of sustain signals assigned to one frame is N. When the APL is “b” level greater than “a” level, the number of sustain signals assigned to one frame is M less than N.

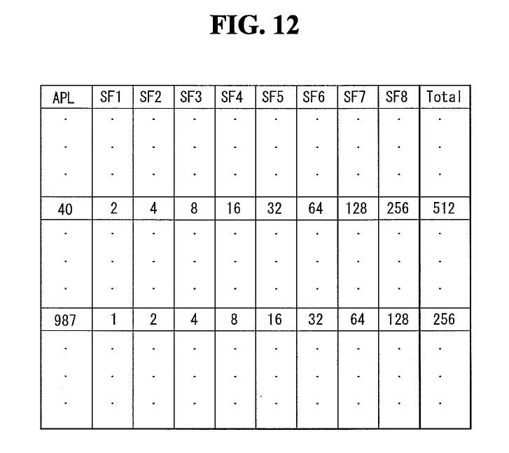

As indicated in a table shown in FIG. 12, the number of sustain signals assigned to each of subfields of one frame and the total number of sustain signals of the one frame may be set based on the APL. For example, when the APL is 40, the total number of sustain signals assigned to one frame is about 512. When the APL is 987, the total number of sustain signals assigned to one frame is about 256.

The embodiment of the invention is not limited to the table shown in FIG. 12, and other tables may be used.

As described above, as the APL of image data increases, the total number of sustain signals assigned to one frame decreases. On the contrary, as the APL of the image data decreases, the total number of sustain signals assigned to one frame increases. Thus, a length of a supply period of a driving signal in one frame may vary depending on the APL.

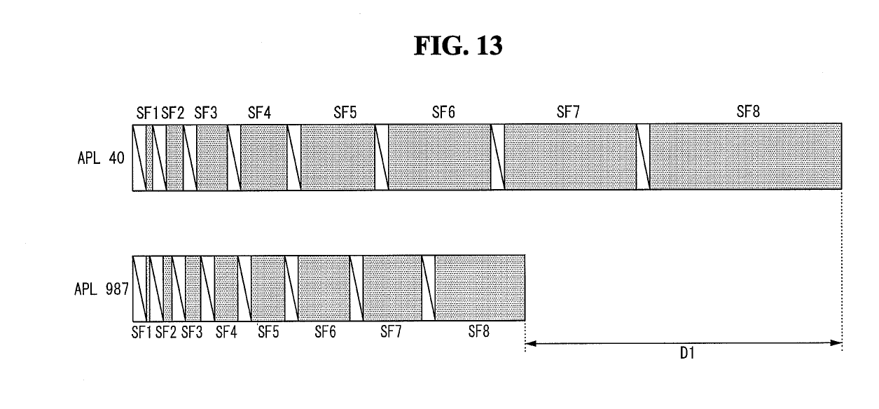

For example, as shown in FIG. 13, a length of a supply period of a driving signal at the APL of 987 may be shorter than a length of a supply period of a driving signal at the APL of 40 by D1.

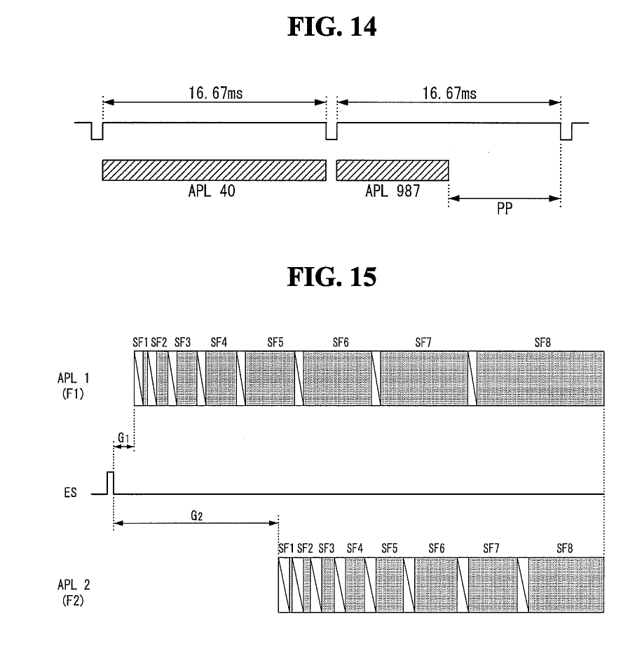

As a result, as shown in FIG. 14, a length of a pause period PP following the supply period of the driving signal in one frame (for example, 16.67 ms) at the APL of 987 may be longer than a length of a pause period PP at the APL of 40

FIGS. 15 to 28 illustrate a method for driving the 3D plasma display according to the example embodiment of the invention. In the following description, the descriptions of the configuration and the structure described above are omitted. For example, the emitter signal may be applied between the left eye frame and the right eye frame of one frame or between two successively arranged frames. Further, the form of the emitter signal may be variously changed.

Further, in the following description, when the emitter signal is applied between the left eye frame and the right eye frame of one frame and between two successively arranged frames, a method for driving the 3D plasma display is described. However, when the emitter signal is not applied to the 3D glasses in one frame, the method for driving the 3D plasma display according to the embodiment of the invention may be applied.

In the following description, two frames divided by the emitter signal ES may be a left eye frame and a right eye frame included in one frame, respectively. Alternatively, each of the two frames may be a frame including a left eye frame and a right eye frame. Alternatively, as shown in FIG. 9, the two frames may be a left eye frame and a right eye frame each constituting one frame, respectively. Namely, in the following description, each of the frames may be a frame including a left eye frame and a right eye frame. Alternatively, the frames may be a left eye frame and a right eye frame each constituting one frame, respectively. Alternatively, the frames may be a left eye frame and a right eye frame included in one frame, respectively.

As shown in FIG. 15, a start time point of a frame may be changed depending on the APL of input image data. Preferably, as the APL of input image data increase, the start time point of the frame may be delayed. Hence, as the APL of the input image data increases, a time difference between the start time point of the frame and the emitter signal ES may increase.

In other words, a time difference between the start time point of the frame and the emitter signal ES when the APL is a first level APL1 may be different from a time difference between the start time point of the frame and the emitter signal ES when the APL is a second level APL2 different from the first level APL1.

For example, it is assumed that an APL of a first frame F1 is the first level APL1 and an APL of a second frame F2 different from the first frame F1 is the second level APL2 higher than the first level APL1.

In this instance, as shown in FIG. 15, a time difference G2 between a start time point of the second frame F2 having the APL of the second level APL2 and the emitter signal ES may be greater than a time difference G1 between a start time point of the first frame F1 having the APL of the first level APL1 and the emitter signal ES.

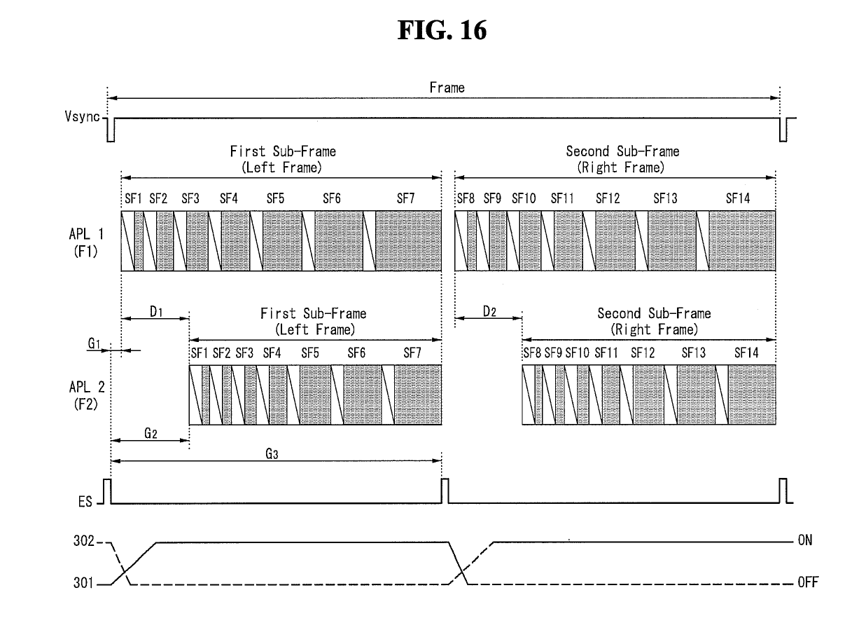

For example, as shown in FIG. 16, when one frame includes a left eye frame and a right eye frame and the emitter signal ES is applied prior to the left eye frame and between the left eye frame and the right eye frame, a time difference G1 between a start time point of the left eye frame and the emitter signal ES at an APL of a first level APL1 may be less than a time difference G2 between a start time point of the left eye frame and the emitter signal ES at an APL of a second level APL2 higher than the first level APL1. Namely, this may indicate that the start time point of the left eye frame at the APL of the first level APL1 is earlier than the start time point of the left eye frame at the APL of the second level APL2 by D1.

The description of FIG. 16 may be applied to the right eye frame. Hereinafter, the embodiment of the invention is described using the left eye frame as an example.

The total number of sustain signals assigned to a second frame F2 having an APL higher than an APL of a first frame F1 may be less than the total number of sustain signals assigned to the first frame F1.

Thus, as shown in FIG. 16, even if a time difference G2 between the emitter signal ES and a start time point of the second frame F2 is greater than a time difference G1 between the emitter signal ES and a start time point of the first frame F1, time required to drive the 3D plasma display may be sufficient.

Further, after the left eye lens 301 is completely turned on at the APL of the second level APL2, a frame may start. Hence, before the left eye lens 301 is completely turned on at the APL of the second level APL2, the frame may be prevented from starting. As a result, a reduction in an amount of light at the APL of the second level APL2 may be prevented. Further, a reduction in a luminance of the 3D image may be prevented.

A time difference G3 between the emitter signal ES and an end time point of a fame at the APL of the second level APL2 may be almost the same as a time difference G3 between the emitter signal ES and the end time point of the fame at the APL of the first level APL1.

Hereinafter, this is described from a different point of view.

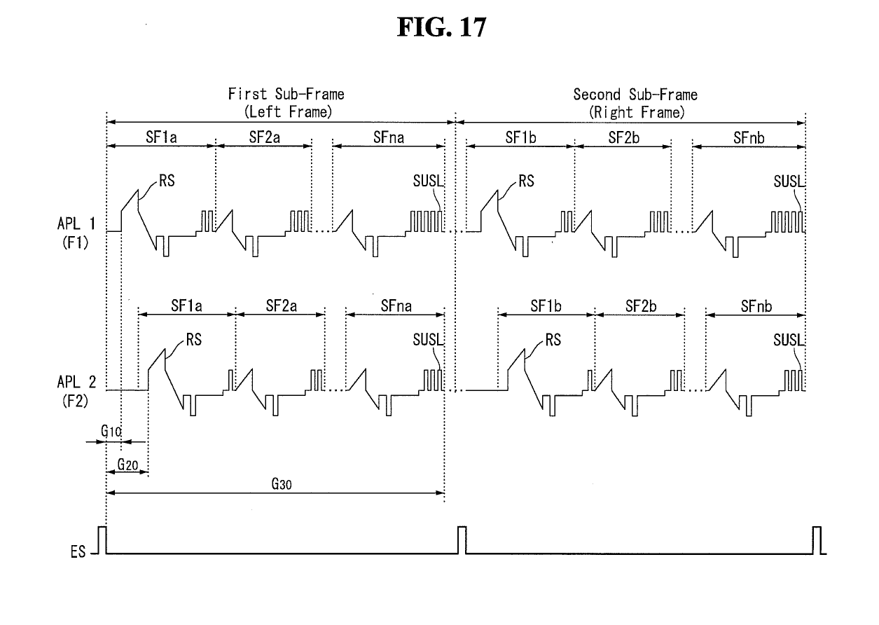

As shown in FIG. 17, a time difference G20 between the emitter signal ES and a reset signal RS supplied to the scan electrode in a reset period RP of a first subfield SF1a of a left eye frame of a second frame F2 having the APL of the second level APL2 may be greater than a time difference G10 between the emitter signal ES and a reset signal RS supplied to the scan electrode in a reset period RP of a first subfield SF1a of a left eye frame of a first frame F1 having the APL of the first level APL1 lower than the second level APL2.

As above, when the time difference G20 is greater than the time difference G10, light generated in the discharge cell may be prevented from being blocked in the process, in which the left eye lens 301 is opened before the left eye lens 301 is completely turned on in the second frame F2. Hence, a reduction in a luminance of the 3D image may be prevented.

Further, because the total number of sustain signals assigned to the second frame F2 is less than the total number of sustain signals assigned to the first frame F1, even if the time difference G20 is greater than the time difference G10, time required to drive the 3D plasma display in the second frame F2 may be sufficient.

A time difference G30 between the emitter signal ES and a last sustain signal SUSL supplied to the scan electrode or the sustain electrode in a sustain period SP of a last subfield SFna of the left eye frame of the second frame F2 may be almost the same as a time difference G30 between the emitter signal ES and a last sustain signal SUSL supplied to the scan electrode or the sustain electrode in a sustain period SP of a last subfield SFna of the left eye frame of the first frame F1.

The description of FIG. 17 may be applied to the right eye frame.

An end time point of a frame may vary depending on the APL of the input image data. This is described below.

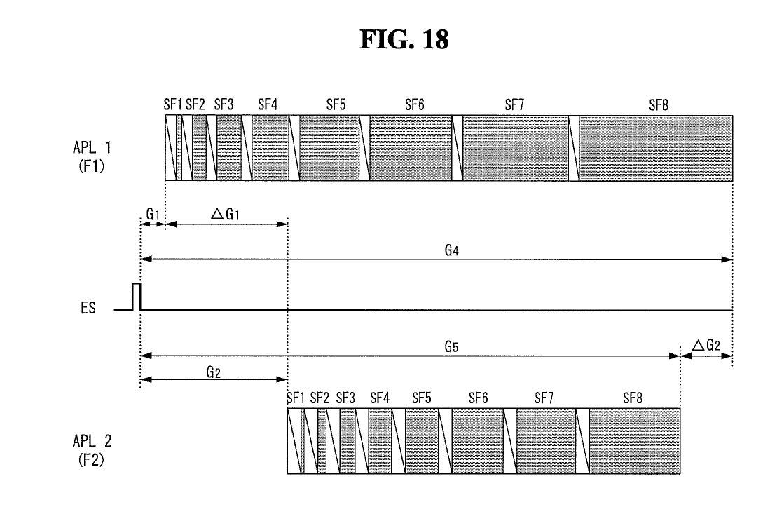

As shown in FIG. 18, a time difference G5 between the emitter signal ES and an end time point of a second frame F2 having the APL of the second level APL2 may be less than a time difference G4 between the emitter signal ES and an end time point of a first frame F1 having the APL of the first level APL1 lower than the second level APL2. Namely, the end time point of the second frame F2 of the second level APL2 may be earlier than the end time point of the first frame F1 of the first level APL1 by ΔG2. Further, a start time point of the second frame F2 of the second level APL2 may be later than a start time point of the first frame F1 of the first level APL1 by ΔG1. ΔG1 may correspond to D1 illustrated in FIG. 16.

In this instance, a light center of the second frame F2 of the second level APL2 may be similar to a light center of the first frame F1 of the first level APL1.

It is assumed that a time difference G2 between the emitter signal ES and a start time point of the second frame F2 having the APL of the second level APL2 is a first time; a time difference G1 between the emitter signal ES and a start time point of the first frame F1 having the APL of the first level APL1 is a second time; a time difference G5 between the emitter signal ES and an end time point of the second frame F2 having the APL of the second level APL2 is a third time; and a time difference G4 between the emitter signal ES and an end time point of the first frame F1 having the APL of the first level APL1 is a fourth time.

In this instance, a difference G2−G1 (i.e., ΔG1) between the first time and the second time may be greater than a difference G4−G5 (i.e., ΔG2) between the third time and the fourth time.

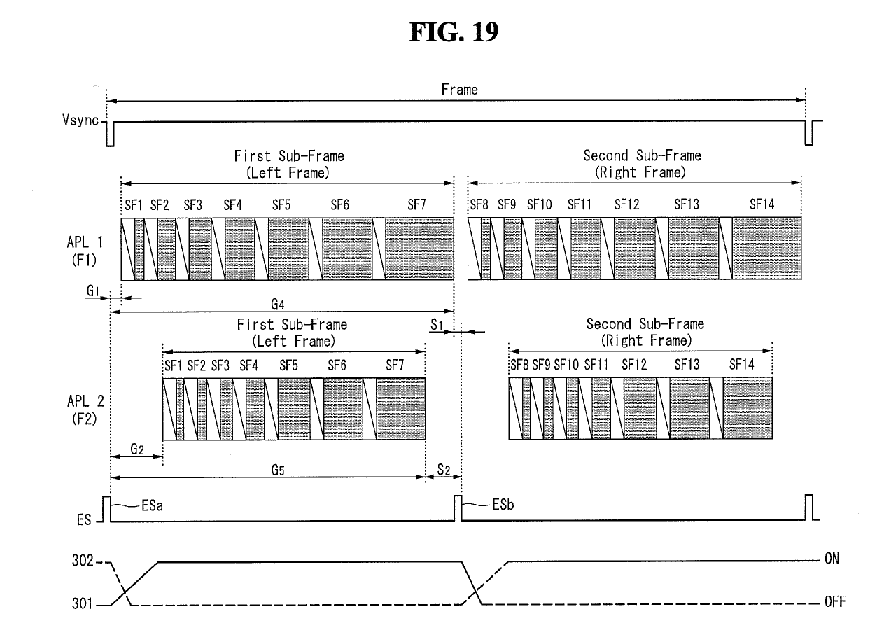

For example, as shown in FIG. 19, when one frame includes a left eye frame (i.e., a first subframe) and a right eye frame (i.e., a second subframe), a time difference G4 between a first emitter signal ESa and an end time point of the left eye frame having the APL of the first level APL1 may be greater than a time difference G5 between the first emitter signal ESa and an end time point of the left eye frame having the APL of the second level APL2 higher than the first level APL1.

In FIG. 19, the emitter signal ES is divided into the first emitter signal ESa and a second emitter signal ESb. The first emitter signal ESa is the emitter signal corresponding to the left eye frame and thus may be a signal, which turns on the left eye lens 301 and turns off the right eye lens 302 in the left eye frame. The second emitter signal ESb is the emitter signal corresponding to the right eye frame and thus may be a signal, which turns off the left eye lens 301 and turns on the right eye lens 302 in the right eye frame.

The first and second emitter signals ESa and ESb may have the configurations shown in FIG. 10. Alternatively, the first and second emitter signals ESa and ESb may have different configurations. For example, the first emitter signal ESa may have the configuration shown in FIG. 10(a), and the second emitter signal ESb may have the configuration shown in FIG. 10(b).

When positions of the left eye frame and the right eye frame of the one frame are changed with each other, positions of the first and second emitter signals ESa and ESb may be changed with each other.

The fact that the end time point of the left eye frame having the APL of the second level APL2 is earlier than the end time point of the left eye frame having the APL of the first level APL1 may mean that a time difference S2 between the end time point of the left eye frame having the APL of the second level APL2 and the second emitter signal ESb following the first emitter signal ESa is greater than a time difference S1 between the end time point of the left eye frame having the APL of the first level APL1 and the second emitter signal ESb.

Hereinafter, this is described from a different point of view.

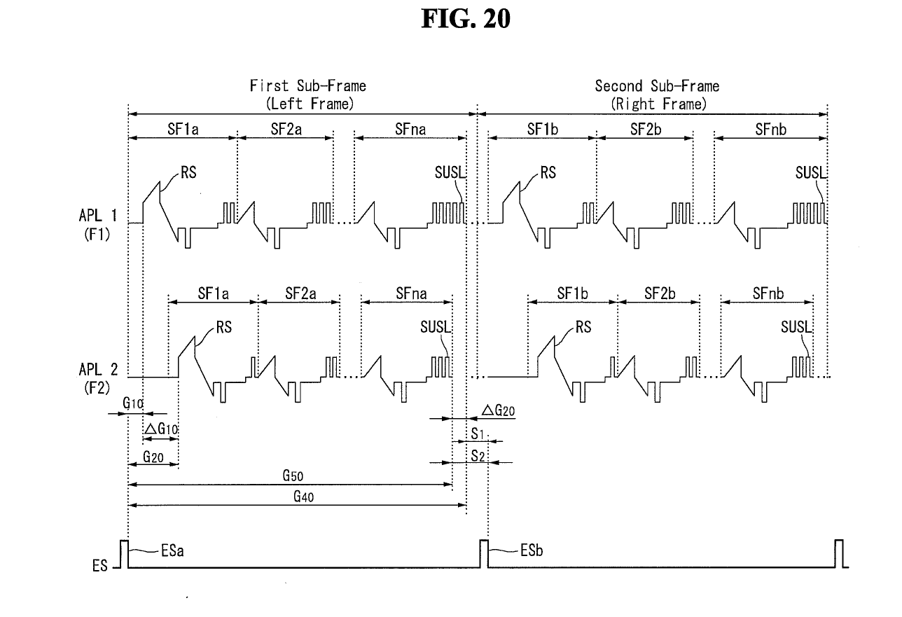

As shown in FIG. 20, a time difference G50 between the first emitter signal ESa and a last sustain signal SUSL supplied to the scan electrode and/or the sustain electrode in a sustain period SP of a last subfield SFna of a left eye frame of a second frame F2 having the APL of the second level APL2 may be less than a time difference G40 between the first emitter signal ESa and a last sustain signal SUSL supplied to the scan electrode and/or the sustain electrode in a sustain period SP of a last subfield SFna of a left eye frame of a first frame F1 having the APL of the first level APL1 lower than the second level APL2.

This means that a time difference S2 between the second emitter signal ESb and the last sustain signal SUSL supplied to the scan electrode and/or the sustain electrode in the sustain period SP of the last subfield SFna of the left eye frame of the second frame F2 may be greater than a time difference S1 between the second emitter signal ESb and the last sustain signal SUSL supplied to the scan electrode and/or the sustain electrode in the sustain period SP of the last subfield SFna of the left eye frame of the first frame F1.

It is assumed that a time difference G20 between the first emitter signal ESa and a reset signal RS supplied to the scan electrode in a reset period RP of a first subfield SF1a of a left eye frame of a second frame F2 having the APL of the second level APL2 is a time 1a; a time difference G10 between the first emitter signal ESa and a reset signal RS supplied to the scan electrode in a reset period RP of a first subfield SF1a of a left eye frame of a first frame F1 having the APL of the first level APL1 is a time 2a; a time difference G50 between the first emitter signal ESa and a last sustain signal SUSL supplied to the scan electrode and/or the sustain electrode in a sustain period SP of a last subfield SFna of the left eye frame of the second frame F2 is a time 3a; and a time difference G40 between the first emitter signal ESa and a last sustain signal SUSL supplied to the scan electrode and/or the sustain electrode in a sustain period SP of a last subfield SFna of the left eye frame of the first frame F1 is a time 4a.

In this instance, a difference G20−G10 (i.e., ΔG10) between the time 1a (i.e., G20) and the time 2a (i.e., G10) may be greater than a difference G50−G40 (i.e., ΔG20) between the time 3a (i.e., G50) and the time 4a (i.e., G40).

As described above, each of the left eye lens 301 and the right eye lens 302 of the 3D glasses may include the liquid crystal layer whose molecular arrangement varies based on a voltage applied to them. Hence, a turn-on period and a turn-off period of each of the left eye lens 301 and the right eye lens 302 may be different from each other.

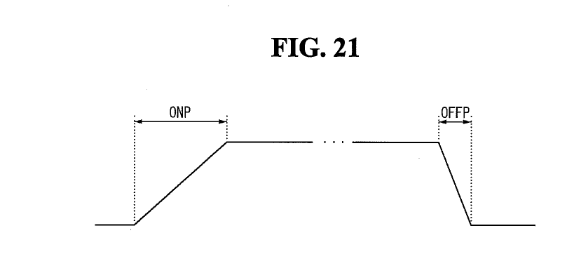

For example, as shown in FIG. 21, when the emitter signal ES is applied to the 3D glasses, the left eye lens 301 or the right eye lens 302 is turned on or off. A length of a turn-on period ONP ranging from a start time point of the turn-on operation of the left eye lens 301 and/or the right eye lens 302 to an end time point of the complete turn-on operation of the left eye lens 301 and/or the right eye lens 302 in response to the emitter signal ES may be longer than a length of a turn-off period OFFP ranging from a start time point of the turn-off operation of the left eye lens 301 and/or the right eye lens 302 to an end time point of the complete turn-off operation of the left eye lens 301 and/or the right eye lens 302 in response to the emitter signal ES.

Namely, a relatively long time is required in the process for opening the left eye lens 301 and/or the right eye lens 302, and a relatively short time is required in the process for closing the left eye lens 301 and/or the right eye lens 302.

Considering the above description, as shown in FIGS. 18 to 20, light generated in the discharge cell may be prevented from being blocked in the process in which the left eye lens 301 and/or the right eye lens 302 are opened in the second frame F2 when ΔG1 and ΔG10 are sufficiently large. Hence, a reduction in a luminance of the 3D image may be prevented. Further, because time required in the process for closing the left eye lens 301 and/or the right eye lens 302 is shorter than time required in the process for opening the left eye lens 301 and/or the right eye lens 302, ΔG2 and ΔG20 may be less than ΔG1 and ΔG10.

Accordingly, it may be preferable that ΔG1 is greater than ΔG2 and ΔG10 is greater than ΔG20.

As the APL of the input image data increases, the end time point of the frame may be delayed. This is described below.

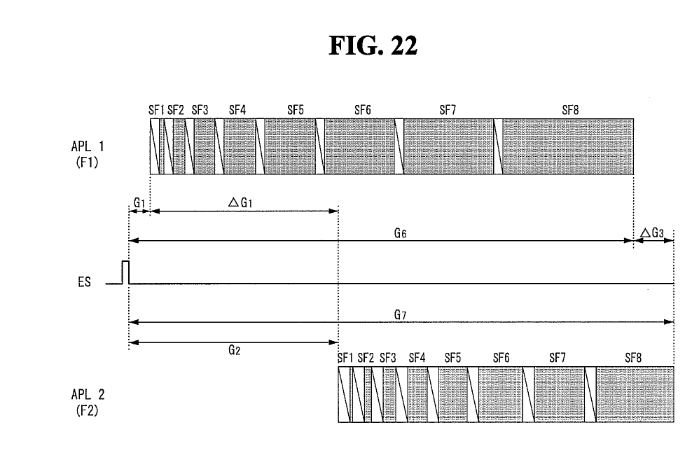

As shown in FIG. 22, a time difference G7 between the emitter signal ES and an end time point of a second frame F2 having the APL of the second level APL2 may be greater than a time difference G6 between the emitter signal ES and an end time point of a first frame F1 having the APL of the first level APL1 lower than the second level APL2. Namely, the end time point of the second frame F2 of the second level APL2 may be later than the end time point of the first frame F1 of the first level APL1 by ΔG3.

In this instance, when there is a relatively small difference between the total number of sustain signals assigned to the second frame F2 of the second level APL2 and the total number of sustain signals assigned to the first frame F1 of the first level APL1, a start time point of the second frame F2 of the second level APL2 may be sufficiently later than a start time point of the first frame F1 of the first level APL1.

It is assumed that a time difference G2 between the emitter signal ES and a start time point of the second frame F2 of the second level APL2 is a 10th time; a time difference G1 between the emitter signal ES and a start time point of the first frame F1 of the first level APL1 is a 20th time; a time difference G7 between the emitter signal ES and an end time point of the second frame F2 of the second level APL2 is a 30th time; and a time difference G6 between the emitter signal ES and an end time point of the first frame F1 of the first level APL1 is a 40th time.

In this instance, a difference G2−G1 (i.e., ΔG1) between the 10th time and the 20th time may be greater than a difference G7−G6 (i.e., ΔG3) between the 30th time and the 40th time.

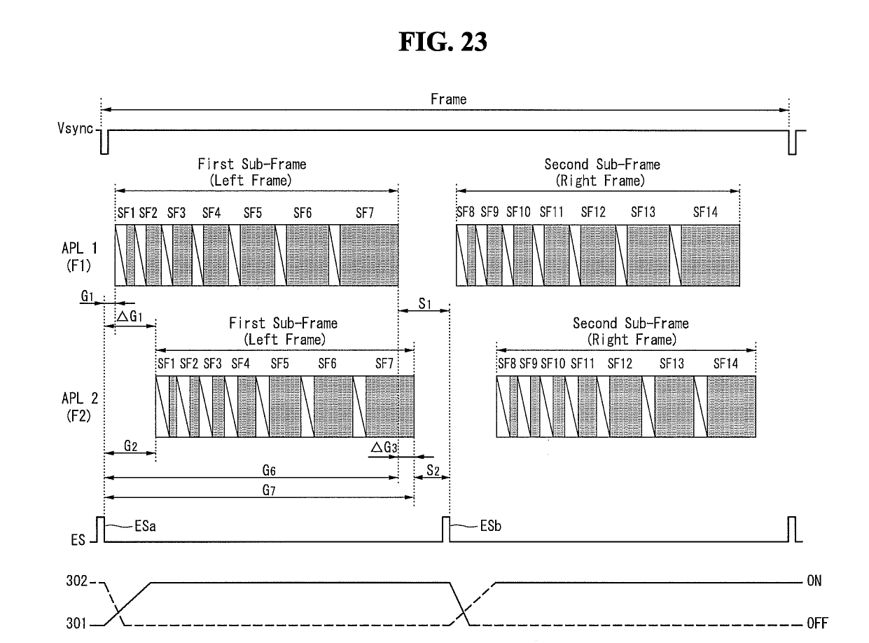

For example, as shown in FIG. 23, when one frame includes a left eye frame (i.e., a first subframe) and a right eye frame (i.e., a second subframe), a time difference G6 between the first emitter signal ESa and an end time point of the left eye frame having the APL of the first level APL1 may be less than a time difference G7 between the first emitter signal ESa and an end time point of the left eye frame having the APL of the second level APL2 higher than the first level APL1.

The fact that the end time point of the left eye frame having the APL of the second level APL2 is later than the end time point of the left eye frame having the APL of the first level APL1 may mean that a time difference S2 between the end time point of the left eye frame having the APL of the second level APL2 and the second emitter signal ESb following the first emitter signal ESa is less than a time difference S1 between the end time point of the left eye frame having the APL of the first level APL1 and the second emitter signal ESb.

Hereinafter, this is described from a different point of view.

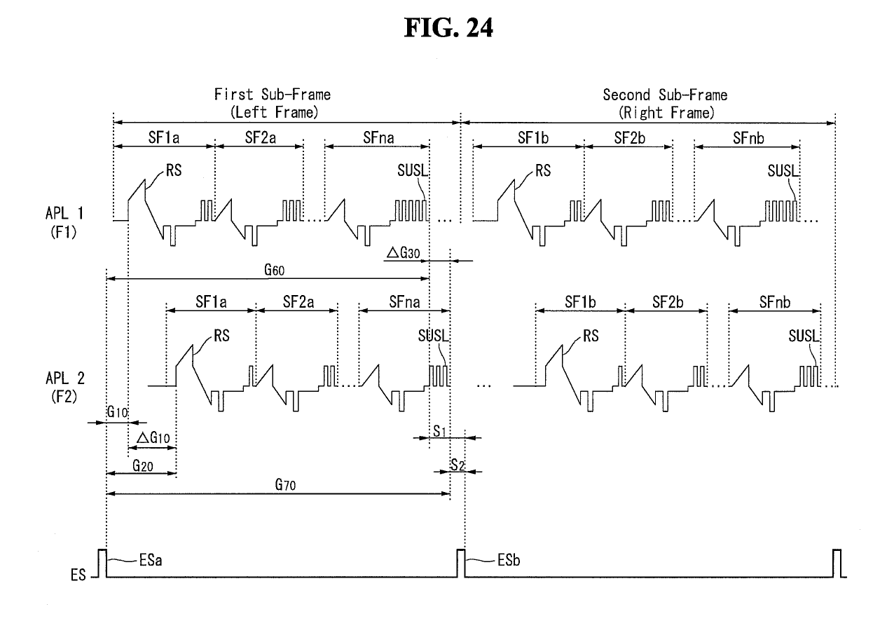

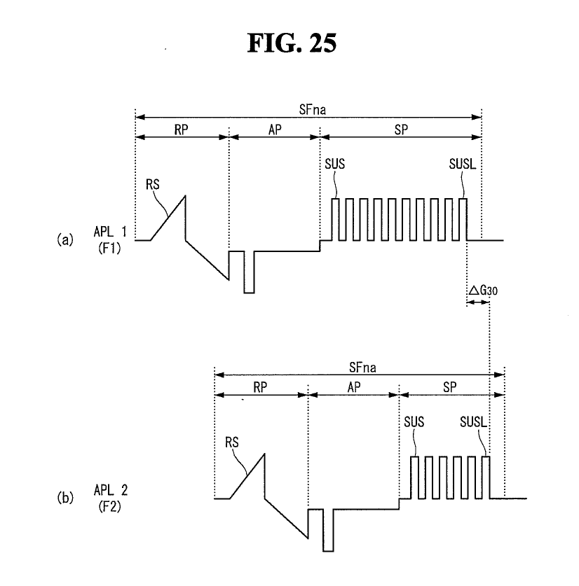

As shown in FIG. 24, a time difference G70 between the first emitter signal ESa and a last sustain signal SUSL supplied to the scan electrode and/or the sustain electrode in a sustain period SP of a last subfield SFna of a left eye frame of a second frame F2 having the APL of the second level APL2 may be greater than a time difference G60 between the first emitter signal ESa and a last sustain signal SUSL supplied to the scan electrode and/or the sustain electrode in a sustain period SP of a last subfield SFna of a left eye frame of a first frame F1 having the APL of the first level APL1 lower than the second level APL2. More specifically, as shown in FIG. 25, a last sustain signal SUSL supplied to the scan electrode and/or the sustain electrode in a sustain period SP of a last subfield SFna of a left eye frame of a second frame F2 may be later than a last sustain signal SUSL supplied to the scan electrode and/or the sustain electrode in a sustain period SP of a last subfield SFna of a left eye frame of a first frame F1 by ΔG30.

In other words, a time difference S2 between the second emitter signal ESb and a last sustain signal SUSL supplied to the scan electrode and/or the sustain electrode in a sustain period SP of a last subfield SFna of a left eye frame of a second frame F2 may be less than a time difference S1 between the second emitter signal ESb and a last sustain signal SUSL supplied to the scan electrode and/or the sustain electrode in a sustain period SP of a last subfield SFna of a left eye frame of a first frame F1.

It is assumed that a time difference G20 between the first emitter signal ESa and a reset signal RS supplied to the scan electrode in a reset period RP of a first subfield SF1a of a left eye frame of a second frame F2 having the APL of the second level APL2 is a 10th time; a time difference G10 between the first emitter signal ESa and a reset signal RS supplied to the scan electrode in a reset period RP of a first subfield SF1a of a left eye frame of a first frame F1 having the APL of the first level APL1 is a 20th time; a time difference G70 between the first emitter signal ESb and a last sustain signal SUSL supplied to the scan electrode and/or the sustain electrode in a sustain period SP of a last subfield SFna of the left eye frame of the second frame F2 is a 30th time; and a time difference G60 between the first emitter signal ESb and a last sustain signal SUSL supplied to the scan electrode and/or the sustain electrode in a sustain period SP of a last subfield SFna of the left eye frame of the first frame F1 is a 40th time.

In this instance, a difference G20−G10 (i.e., ΔG10) between the 10th time and the 20th time may be greater than a difference G70−G60 (i.e., ΔG30) between the 30th time and the 40th time.

The light emission characteristic of the phosphor may vary depending on the number of sustain signals. More specifically, as the number of sustain signals increases, a return time required to return the phosphor to a normal state after the phosphor emits light may increase, and vice versa.

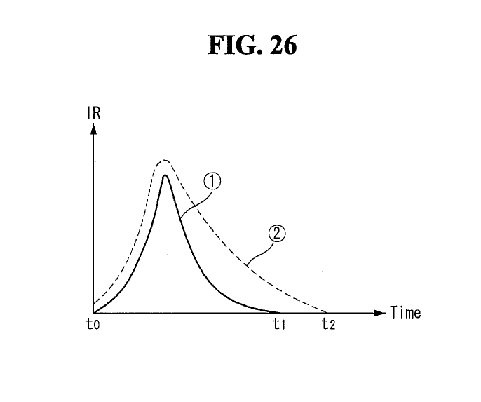

For example, as shown in FIG. 26, in a case \textcircled{1} where the sustain discharge occurs in the discharge cell using a total of 10 sustain signals, a time ranging from a time point t0 at which the phosphor starts to emit light to a time point t1 at which the light emission of the phosphor ends may be relatively short. In a case \textcircled{2} where the sustain discharge occurs in the discharge cell using a total of 1000 sustain signals, a time ranging from a time point t0 at which the phosphor starts to emit light to a time point t2 at which the light emission of the phosphor ends may be relatively long.

Considering the above description, as shown in FIGS. 22 to 25, when the time difference G70 between the first emitter signal ESa and the last sustain signal SUSL supplied to the scan electrode and/or the sustain electrode in the sustain period SP of the last subfield SFna of the left eye frame of the second frame F2 having the APL of the second level APL2 is greater than the time difference G60 between the first emitter signal ESa and the last sustain signal SUSL supplied to the scan electrode and/or the sustain electrode in the sustain period SP of the last subfield SFna of the left eye frame of the first frame F1 having the APL of the first level APL1 lower than the second level APL2, the number of sustain signals assigned to the sustain period SP of the last subfield SFna of the left eye frame of the second frame F2 is less than the number of sustain signals assigned to the sustain period SP of the last subfield SFna of the left eye frame of the first frame F1. Therefore, a time point at which the light generation ends in the sustain period SP of the last subfield SFna of the left eye frame of the second frame F2 may be almost similar to a time point at which the light generation ends in the sustain period SP of the last subfield SFna of the left eye frame of the first frame F1.

Accordingly, even if an end time point of the sustain period SP of the last subfield SFna of the left eye frame of the second frame F2 is later than an end time point of the sustain period SP of the last subfield SFna of the left eye frame of the first frame F1, an excessive reduction in the luminance of the 3D image may be prevented.

Further, as shown in FIGS. 22 to 25, the total number of sustain signals assigned to the second frame F2 is less than the total number of sustain signals assigned to the first frame F1, but an end time point of the second frame F2 is later than an end time point of the first frame F1. Therefore, it may be preferable that the difference G2−G1(ΔG1) or G20−G10 (i.e., ΔG10) between the 10th time (i.e., G2 or G20) and the 20th time (i.e., G1 or G10) may be greater than the difference G7−G6(ΔG3) or G70−G60 (i.e., ΔG30) between the 30th time (i.e., G7 or G70) and the 40th time (i.e., G6 or G60).

Further, the above-described methods may be mixed with one another. This is described below.

When the APL of the input image data is X+A-level, where X and A are a natural number, an end time point of a frame having the APL of the X+A-level may be later than an end time point of a frame having the APL of X-level. When the APL of the input image data is X+A+B-level, where B is a natural number, an end time point of a frame having the APL of the X+A+B-level may be earlier than the end time point of the frame having the APL of X-level.

For example, it is assumed that a first frame F1 has an APL of a first level APL1, a second frame F2 has an APL of a second level APL2 higher than the first level APL1, and a third frame F3 has an APL of a third level APL3 higher than the second level APL2.

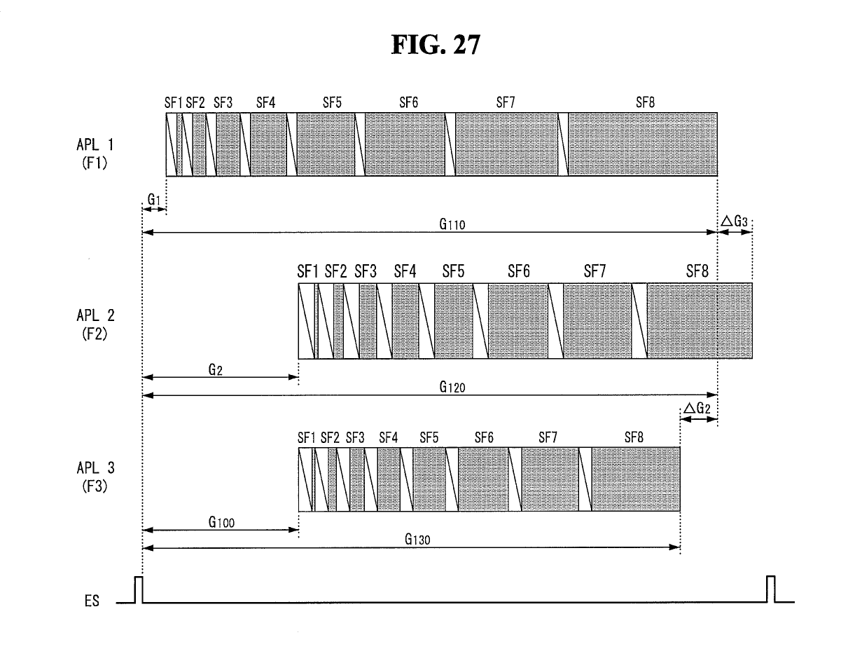

In this instance, as shown in FIG. 27, a time difference G2 between the emitter signal ES and a start time point of the second frame F2 having the APL of the second level APL2 may be greater than a time difference G1 between the emitter signal ES and a start time point of the first frame F1 having the APL of the first level APL1 lower than the second level APL2. Further, a time difference G100 between the emitter signal ES and a start time point of the third frame F3 having the APL of the third level APL3 higher than the second level APL2 may be greater than the time difference G1 between the emitter signal ES and the start time point of the first frame F1 having the APL of the first level APL1 lower than the third level APL3.

In this instance, the time difference G100 may be almost the same as or different from the time difference G2. It may be preferable that the time difference G100 is almost the same as the time difference G2 for the simpler drive.

Further, a time difference G120 between the emitter signal ES and an end time point of the second frame F2 may be greater than a time difference G110 between the emitter signal ES and an end time point of the first frame F1. Namely, the end time point of the second frame F2 having the APL of the second level APL2 may be later than the end time point of the first frame F1 having the APL of the first level APL1 by ΔG3.

A time difference G130 between the emitter signal ES and an end time point of the third frame F3 may be less than the time difference G110 between the emitter signal ES and the end time point of the first frame F1. Namely, the end time point of the third frame F3 having the APL of the third level APL3 may be earlier than the end time point of the first frame F1 having the APL of the first level APL1 by ΔG2.

In other words, a time difference between the first emitter signal ESa and a last sustain signal SUSL supplied to the scan electrode and/or the sustain electrode in a sustain period SP of a last subfield SFna of a left eye frame of the second frame F2 having the APL of the second level APL2 may be greater than a time difference between the first emitter signal ESa and a last sustain signal SUSL supplied to the scan electrode and/or the sustain electrode in a sustain period SP of a last subfield SFna of a left eye frame of the first frame F1 having the APL of the first level APL1 lower than the second level APL2. This was described in detail in FIG. 24. Further, a time difference between the first emitter signal ESa and a last sustain signal SUSL supplied to the scan electrode and/or the sustain electrode in a sustain period SP of a last subfield SFna of a left eye frame of the third frame F3 having the APL of the third level APL3 may be less than the time difference between the first emitter signal ESa and the last sustain signal SUSL supplied to the scan electrode and/or the sustain electrode in the sustain period SP of the last subfield SFna of the left eye frame of the first frame F1 having the APL of the first level APL1 lower than the third level APL3. This was described in detail in FIG. 20.

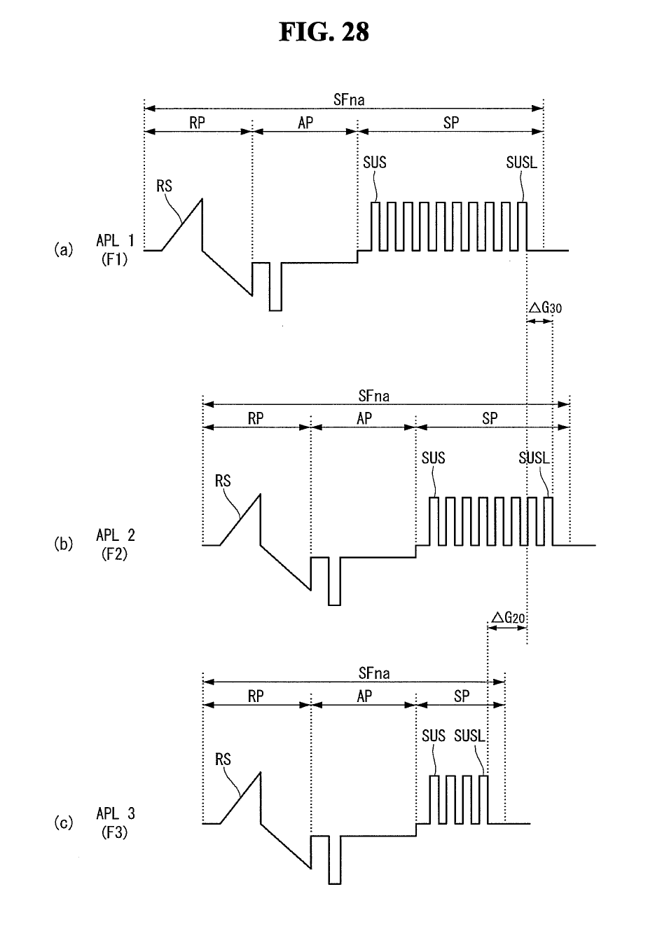

More specifically, as shown in FIG. 28, a last sustain signal SUSL supplied to the scan electrode and/or the sustain electrode in a sustain period SP of a last subfield SFna of a left eye frame of the second frame F2 may be generated later than a last sustain signal SUSL supplied to the scan electrode and/or the sustain electrode in a sustain period SP of a last subfield SFna of a left eye frame of the first frame F1 by ΔG30.

Further, a last sustain signal SUSL supplied to the scan electrode and/or the sustain electrode in a sustain period SP of a last subfield SFna of a left eye frame of the third frame F3 may be generated earlier than the last sustain signal SUSL supplied to the scan electrode and/or the sustain electrode in the sustain period SP of the last subfield SFna of the left eye frame of the first frame F1 by ΔG20.

For example, the first level APL1 may be the APL of 40 at which the total number of sustain signals assigned to one frame is about 512, the second level APL2 may be the APL of 100 at which the total number of sustain signals assigned to one frame is about 450, and the third level APL3 may be the APL of 987 at which the total number of sustain signals assigned to one frame is about 256.

A difference between the total number of sustain signals assigned to one frame at the first level APL1 and the total number of sustain signals assigned to one frame at the second level APL2 is 62. A difference between the total number of sustain signals assigned to one frame at the first level APL1 and the total number of sustain signals assigned to one frame at the third level APL3 is 256.

There is a relatively small difference between the total number of sustain signals assigned to the frame (i.e., the first frame) at the first level APL1 and the total number of sustain signals assigned to the frame (i.e., the second frame) at the second level APL2. Further, a return time of the phosphor in the sustain period SP of the last subfield SFna of the left eye frame of the second frame F2 is shorter than a return time of the phosphor in the sustain period SP of the last subfield SFna of the left eye frame of the first frame F1. Therefore, an end time point of the second frame F2 may be later than an end time point of the first frame F1

On the other hand, there is a relatively large difference between the total number of sustain signals assigned to the frame (i.e., the first frame) at the first level APL1 and the total number of sustain signals assigned to the frame (i.e., the third frame) at the third level APL3. Therefore, even if a start time point of the third frame is later than a start time point of the first frame, an end time point of the third frame may be earlier than an end time point of the first frame.

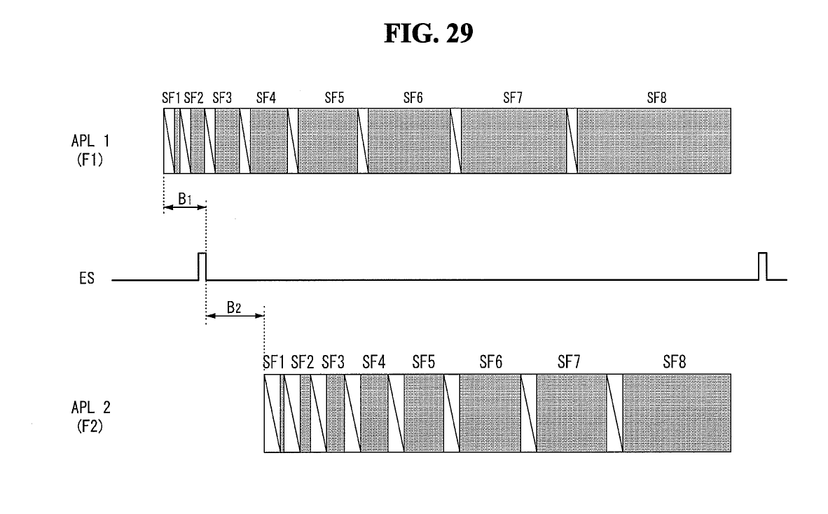

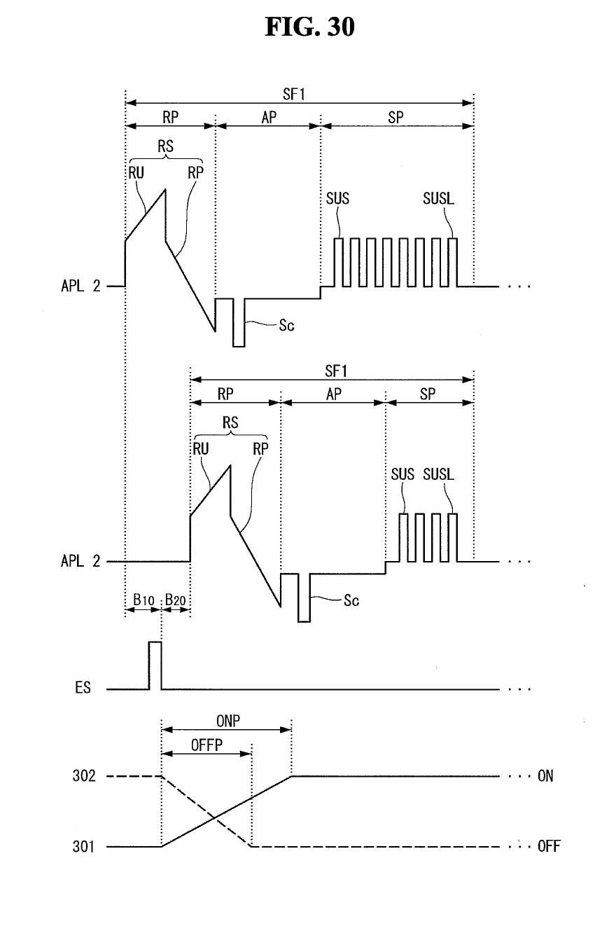

FIGS. 29 and 30 illustrate another method for driving the 3D plasma display according to the example embodiment of the invention.

As shown in FIG. 29, a start time point of a first frame F1 having the APL of the first level APL1 may be earlier than the emitter signal ES by a predetermined time B1. A start time point of a second frame F2 having the APL of the second level APL2 higher than the first level APL1 may be later than the emitter signal ES by a predetermined time B2.

Hereinafter, this is described from a different point of view.

As shown in FIG. 30, an application time point of a reset signal RS supplied to the scan electrode in a reset period RP of a first subfield SF1 of a left eye frame of a second frame F2 having the APL of the second level APL2 may be later than an application time point of the emitter signal ES by a predetermined time B20. An application time point of a reset signal RS supplied to the scan electrode in a reset period RP of a first subfield SF1 of a left eye frame of a first frame F1 having the APL of the first level APL1 lower than the second level APL2 may be earlier than the application time point of the emitter signal ES by a predetermined time B10.

In this instance, a turn-on period ONP of the left eye lens 301 may overlap the reset period RP of the first subfield SF1 of the first frame F1 or the reset period and an address period AP of the first subfield SF1 of the first frame F1. In this instance, the left eye lens 301 may be completely turned on in a sustain period SP of the first subfield SF1 of the first frame F1. Therefore, light generated in the sustain period SP may be prevented from being blocked by the left eye lens 301. As a result, an excessive reduction in the luminance of the 3D image may be prevented.

Further, because an application time point of the reset signal RS in the first frame F1 is earlier than the application time point of the emitter signal ES, the total number of sustain signals assigned to the first frame F1 may increase. In this instance, an excessive reduction in the luminance of the 3D image may be prevented.

The above-described driving method illustrated in FIGS. 1 to 27 may be applied to the driving method illustrated in FIGS. 29 and 30.

For example, although it is not shown, a time difference between the emitter signal ES and a last sustain signal supplied to the scan electrode and/or the sustain electrode in a sustain period of a last subfield of the second frame F2 may be less than a time difference between the emitter signal ES and a last sustain signal supplied to the scan electrode and/or the sustain electrode in a sustain period of a last subfield of the first frame F1. This was described in detail in FIGS. 18 to 21.

Alternatively, although it is not shown, a time difference between the emitter signal ES and a last sustain signal supplied to the scan electrode and/or the sustain electrode in a sustain period of a last subfield of the second frame F2 may be almost the same as a time difference between the emitter signal ES and a last sustain signal supplied to the scan electrode and/or the sustain electrode in a sustain period of a last subfield of the first frame F1. This was described in detail in FIGS. 15 to 17.

Alternatively, although it is not shown, a time difference between the emitter signal ES and a last sustain signal supplied to the scan electrode and/or the sustain electrode in a sustain period of a last subfield of the second frame F2 may be greater than a time difference between the emitter signal ES and a last sustain signal supplied to the scan electrode and/or the sustain electrode in a sustain period of a last subfield of the first frame F1. This was described in detail in FIGS. 22 to 26.

Alternatively, although it is not shown, a time difference between the emitter signal ES and a last sustain signal supplied to the scan electrode and/or the sustain electrode in a sustain period of a last subfield of the second frame F2 may be greater than a time difference between the emitter signal ES and a last sustain signal supplied to the scan electrode and/or the sustain electrode in a sustain period of a last subfield of the first frame F1. Further, a time difference between the emitter signal ES and a last sustain signal supplied to the scan electrode and/or the sustain electrode in a sustain period of a last subfield of the third frame F3, in which the total number of sustain signals is less than the total number of sustain signals assigned to the second frame F2, may be less than the time difference between the emitter signal ES and the last sustain signal supplied to the scan electrode and/or the sustain electrode in the sustain period of the last subfield of the first frame F1. This was described in detail in FIGS. 27 and 28.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A 3D plasma display comprising:
a plasma display panel; and
a driver configured to implement an image on a screen of the plasma display panel in a frame including a plurality of subfields and transmit an emitter signal to 3D glasses,
wherein a time difference between the emitter signal and a start time point of the frame when an average power level (APL) is a first level is different from a time difference between the emitter signal and a start time point of the frame when the APL is a second level different from the first level.

2. The 3D plasma display of claim 1, wherein the second level is higher than the first level,
wherein the time difference between the emitter signal and the start time point of the frame at the APL of the second level is greater than the time difference between the emitter signal and the start time point of the frame at the APL of the first level.

3. The 3D plasma display of claim 2, wherein a time difference between the emitter signal and an end time point of the frame at the APL of the second level is less than a time difference between the emitter signal and an end time point of the frame at the APL of the first level.

4. The 3D plasma display of claim 3, wherein the time difference between the emitter signal and the start time point of the frame at the APL of the second level is called a first time, the time difference between the emitter signal and the start time point of the frame at the APL of the first level is called a second time, the time difference between the emitter signal and the end time point of the frame at the APL of the second level is called a third time, and the time difference between the emitter signal and the end time point of the frame at the APL of the first level is called a fourth time,
wherein a difference between the first time and the second time is greater than a difference between the third time and the fourth time.

5. The 3D plasma display of claim 2, wherein a time difference between the emitter signal and an end time point of the frame at the APL of the second level is almost the same as a time difference between the emitter signal and an end time point of the frame at the APL of the first level.

6. The 3D plasma display of claim 1, wherein the emitter signal is a signal for turning on or off each of a left eye lens and a right eye lens of the 3D glasses.

7. The 3D plasma display of claim 1, wherein the frame includes a left eye frame including at least one of the plurality of subfields and a right eye frame including at least one of the plurality of subfields.

8. The 3D plasma display of claim 7, wherein the emitter signal is generated between two successively arranged frames and between the left eye frame and the right eye frame.

9. The 3D plasma display of claim 1, wherein the emitter signal is generated between two successively arranged frames.

10. The 3D plasma display of claim 2, wherein a time difference between the emitter signal and an end time point of the frame at the APL of the second level is greater than a time difference between the emitter signal and an end time point of the frame at the APL of the first level.

11. The 3D plasma display of claim 10, wherein the time difference between the emitter signal and the start time point of the frame at the APL of the second level is called a 10th time, the time difference between the emitter signal and the start time point of the frame at the APL of the first level is called a 20th time, the time difference between the emitter signal and the end time point of the frame at the APL of the second level is called a 30th time, and the time difference between the emitter signal and the end time point of the frame at the APL of the first level is called a 40th time,
wherein a difference between the 10th time and the 20th time is greater than a difference between the 30th time and the 40th time.

12. The 3D plasma display of claim 2, wherein a time difference between the emitter signal and an end time point of the frame at the APL of the second level is greater than a time difference between the emitter signal and an end time point of the frame at the APL of the first level,
wherein a time difference between the emitter signal and an end time point of the frame at the APL of a third level higher than the second level is less than the time difference between the emitter signal and the end time point of the frame at the APL of the first level.

13. A 3D plasma display comprising:
a plasma display panel including a scan electrode and a sustain electrode positioned parallel to each other;
3D glasses including a left eye lens and a right eye lens; and
a driver configured to implement an image on a screen of the plasma display panel in a frame including a plurality of subfields and transmit an emitter signal to the 3D glasses,
wherein the driver supplies a reset signal to the scan electrode in a reset period of at least one of the plurality of subfields and supplies a sustain signal to at least one of the scan electrode and the sustain electrode in a sustain period following the reset period,
wherein the total number of sustain signals assigned to a second frame belonging to the frame is less than the total number of sustain signals assigned to a first frame belonging to the frame,
wherein a time difference between the emitter signal and the reset signal supplied to the scan electrode in a reset period of a first subfield of the second frame is greater than a time difference between the emitter signal and the reset signal supplied to the scan electrode in a reset period of a first subfield of the first frame.

14. The 3D plasma display of claim 13, wherein a time difference between the emitter signal and a last sustain signal supplied to the scan electrode or the sustain electrode in a sustain period of a last subfield of the second frame is less than a time difference between the emitter signal and a last sustain signal supplied to the scan electrode or the sustain electrode in a sustain period of a last subfield of the first frame.

15. The 3D plasma display of claim 14, wherein the time difference between the emitter signal and the reset signal supplied to the scan electrode in the reset period of the first subfield of the second frame is called a first time, the time difference between the emitter signal and the reset signal supplied to the scan electrode in the reset period of the first subfield of the first frame is called a second time, the time difference between the emitter signal and the last sustain signal supplied to the scan electrode or the sustain electrode in the sustain period of the last subfield of the second frame is called a third time, and the time difference between the emitter signal and the last sustain signal supplied to the scan electrode or the sustain electrode in the sustain period of the last subfield of the first frame is called a fourth time,
wherein a difference between the first time and the second time is greater than a difference between the third time and the fourth time.

16. The 3D plasma display of claim 13, wherein a time difference between the emitter signal and a last sustain signal supplied to the scan electrode or the sustain electrode in a sustain period of a last subfield of the second frame is almost the same as a time difference between the emitter signal and a last sustain signal supplied to the scan electrode or the sustain electrode in a sustain period of a last subfield of the first frame.

17. The 3D plasma display of claim 13, wherein the frame includes a left eye frame including at least one of the plurality of subfields and a right eye frame including at least one of the plurality of subfields.

18. The 3D plasma display of claim 13, wherein a time difference between the emitter signal and a last sustain signal supplied to the scan electrode or the sustain electrode in a sustain period of a last subfield of the second frame is greater than a time difference between the emitter signal and a last sustain signal supplied to the scan electrode or the sustain electrode in a sustain period of a last subfield of the first frame.

19. The 3D plasma display of claim 18, wherein the time difference between the emitter signal and the reset signal supplied to the scan electrode in the reset period of the first subfield of the second frame is called a 10th time, the time difference between the emitter signal and the reset signal supplied to the scan electrode in the reset period of the first subfield of the first frame is called a 20th time, the time difference between the emitter signal and the last sustain signal supplied to the scan electrode or the sustain electrode in the sustain period of the last subfield of the second frame is called a 30th time, and the time difference between the emitter signal and the last sustain signal supplied to the scan electrode or the sustain electrode in the sustain period of the last subfield of the first frame is called a 40th time,
wherein a difference between the 10th time and the 20th time is greater than a difference between the 30th time and the 40th time.

20. A 3D plasma display comprising:
a plasma display panel including a scan electrode and a sustain electrode positioned parallel to each other;
3D glasses including a left eye lens and a right eye lens; and
a driver configured to implement an image on a screen of the plasma display panel in a frame including a plurality of subfields and transmit an emitter signal to the 3D glasses,
wherein the driver supplies a reset signal to the scan electrode in a reset period of at least one of the plurality of subfields and supplies a sustain signal to at least one of the scan electrode and the sustain electrode in a sustain period following the reset period,
wherein the total number of sustain signals assigned to a second frame belonging to the frame is less than the total number of sustain signals assigned to a first frame belonging to the frame,
wherein an application time point of the reset signal supplied to the scan electrode in a reset period of a first subfield of the first frame is earlier than an application time point of the emitter signal,
wherein an application time point of the reset signal supplied to the scan electrode in a reset period of a first subfield of the second frame is later than the application time point of the emitter signal.
